(19) United States
(12) Patent Application Publication
(10) Pub. No.: US 2023/0282107 A1
(43) Pub. Date: Sep. 7, 2023

(54) TRAFFIC COMMAND SYSTEM

(71) Applicant: Continental Automotive Systems, Inc., Auburn Hills, MI (US)

(72) Inventors: Rujiao Yan, Oberursel (DE); Xian Zhang, Shelby Township, MI (US); Matthew Donald Berkemeier, Beverly Hills, MI (US)

(73) Assignee: Continental Automotive Systems, Inc., Auburn Hills, MI (US)

(21) Appl. No.: 17/652,932

(22) Filed: Mar. 1, 2022

(51) Int. Cl. G08G 1/0967; G08G 1/01; B60W 60/00

(52) U.S. Cl. CPC G08G 1/096725; G08G 1/0137; G08G 1/0125; B60W 60/001; B60W 2552/10; B60W 2554/406; B60W 2554/4045; B60W 2556/45

(57) ABSTRACT

A method includes detecting a traffic disturbance in a first lane of a road with a plurality of lanes. The traffic disturbance is categorized into a category. Movement characteristics of a plurality of vehicles in the proximity of the traffic disturbance are sensed. A traffic alleviation strategy is developed based on the category of the traffic disturbance and the movement characteristics. At least one traffic command is sent to a processor of at least one vehicle based on the traffic alleviation strategy.

### BACKGROUND

The present disclosure relates to a system that provides traffic commands to vehicles to optimally address a traffic disturbance.

Traffic disturbances happen frequently on the road, including vehicles attempting to merge lanes, breaking down, or being involved in an accident. These disturbances may cause a back-up of traffic in the lane behind the disturbance, and generally lead to congestion. Individual responses to these traffic disturbances may not result in an optimal global solution that will reduce overall traffic congestion or drive times of all vehicles affected by the traffic disturbance.

For example, in a scenario where a first vehicle on a multi-lane road slows down or stops to attempt to merge from a first lane into a second lane to make a turn, it is in the driver of that vehicles' interest to stop until they can merge and proceed on their desired route. It also may be in the best interest of other drivers in the second lane to decline to stop to allow ingress for the first vehicle, as this may cause them delay. However, the halted first vehicle may cause a back-up of traffic and congestion which is negatively impactful to the collective drivers on the road. The first vehicle proceeding straight or the vehicles in the second lane allowing ingress may be more beneficial for overall traffic flow.

Another common scenario where the interest of the individual and the collective diverge is when a more permeant traffic disturbance, such as a broken-down vehicle or accident, obstructs a first lane of a multi-lane road, but not a second lane. It may be in the best interest of drivers in the unobstructed second lane to proceed without allowing vehicles in the first lane to merge to get around the traffic disturbance. However, a “zipper” merge may be more beneficial for overall traffic flow.

Accordingly, it is desirable to have a system that issues traffic commands to vehicles that override the individual's interest in an attempt to achieve an optimal response to traffic disturbances.

### SUMMARY

In one exemplary embodiment, a method includes detecting a traffic disturbance in a first lane of a road with a plurality of lanes. The traffic disturbance is categorized into a category. Movement characteristics of a plurality of vehicles in the proximity of the traffic disturbance are sensed. A traffic alleviation strategy is developed based on the category of the traffic disturbance and the movement characteristics. At least one traffic command is sent to a processor of at least one vehicle based on the traffic alleviation strategy.

In another embodiment according to any of the previous embodiments, the step of developing the traffic alleviation strategy includes determining vehicle movements that will reduce overall traffic congestion in the proximity of the traffic disturbance.

In another embodiment according to any of the previous embodiments, the step of developing the traffic alleviation strategy includes determining vehicle movements that will reduce a total estimated drivetime of all vehicles on the road in the proximity of the traffic disturbance.

In another embodiment according to any of the previous embodiments, traffic disturbance identification data is stored prior to the step of detecting. The step of categorizing includes comparing the traffic disturbance to the traffic disturbance identification data.

In another embodiment according to any of the previous embodiments, the category of the traffic disturbance is a disturbing vehicle attempting to merge from the first lane to a second lane of the road.

In another embodiment according to any of the previous embodiments, developing the traffic alleviation strategy includes determining a time limit for allowing the disturbing vehicle to attempt to change lanes. The traffic command is communicated after the time limit.

In another embodiment according to any of the previous embodiments, the traffic command comprises one of instructing the disturbing vehicle to proceed straight. A vehicle in the second lane is instructed to allow the disturbing vehicle to merge into the second lane.

In another embodiment according to any of the previous embodiments, developing the traffic alleviation strategy includes determining additional drivetime associated with the disturbing vehicle proceeding in the first lane and determining additional drivetime associated with a vehicle in the second lane allowing the disturbing vehicle to merge into the second lane.

In another embodiment according to any of the previous embodiments, the category of the traffic disturbance is an immobile disturbance. The traffic command comprises instructing an alternating merge pattern.

In another exemplary embodiment, a system includes one or more sensors detecting a traffic disturbance in a first lane of a road with a plurality of lanes and detecting movement characteristics of vehicles in the proximity of the traffic disturbance. The sensors communicate data to a controller. A communication means is in communication with the controller. The controller categorizes the traffic disturbance into a category. The controller develops a traffic alleviation strategy based on the category of the traffic disturbance and the movement characteristics. The controller instructs the communication means to communicate a traffic command to a processor of at least one vehicle based on the traffic alleviation strategy.

In another embodiment according to any of the previous embodiments, the traffic alleviation strategy includes determined vehicle movements that will reduce a total estimated drivetime of all vehicles on the road in the proximity of the traffic disturbance.

In another embodiment according to any of the previous embodiments, the category of the traffic disturbance is a disturbing vehicle attempting to merge from the first lane to a second lane of the road.

In another embodiment according to any of the previous embodiments, the traffic command comprises one of instructing the disturbing vehicle to proceed straight. A vehicle in the second lane is instructed to allow the disturbing vehicle to merge into the second lane.

In another embodiment according to any of the previous embodiments, the controller develops the traffic alleviation strategy by determining additional drivetime associated with the disturbing vehicle proceeding in the first lane and determining additional drivetime associated with a vehicle in the second lane allowing the disturbing vehicle to merge into the second lane.

In another embodiment according to any of the previous embodiments, the category of the traffic disturbance is an immobile disturbance and the traffic command instructs an alternating merge pattern.

In another embodiment according to any of the previous embodiments, the controller incorporates a machine-learning component to develop traffic disturbance identification data. The controller categorizes the traffic disturbance by comparing the traffic disturbance to the traffic disturbance identification data.

In another embodiment according to any of the previous embodiments, the traffic disturbance is a disturbing vehicle. The controller receives information from a processor of the disturbing vehicle to categorize the traffic disturbance.

In another embodiment according to any of the previous embodiments, the traffic command instructs the processor to autonomously move the at least one vehicle.

In another exemplary embodiment, a non-transitory computer readable medium includes instruction executable by at least one processor. The instructions include instructions executed by the at least one processor that prompt categorizing a traffic disturbance in a first lane of a road with a plurality of lanes into a category. Instructions are executed by the at least one processor that prompt developing a traffic alleviation strategy based on the category of the traffic disturbance and movement characteristics of vehicles in the proximity of the traffic disturbance. Instructions are executed by the at least one processor that prompt sending at least one traffic command to a processor of at least one vehicle based on the traffic alleviation strategy.

In another embodiment according to any of the previous embodiments, developing the traffic alleviation strategy includes determining vehicle movements that will reduce a total estimated drivetime of all vehicles on the road in the proximity of the traffic disturbance.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a road incorporating a traffic command system.

FIG. 2 illustrates a traffic command algorithm of a traffic command system.

### DESCRIPTION

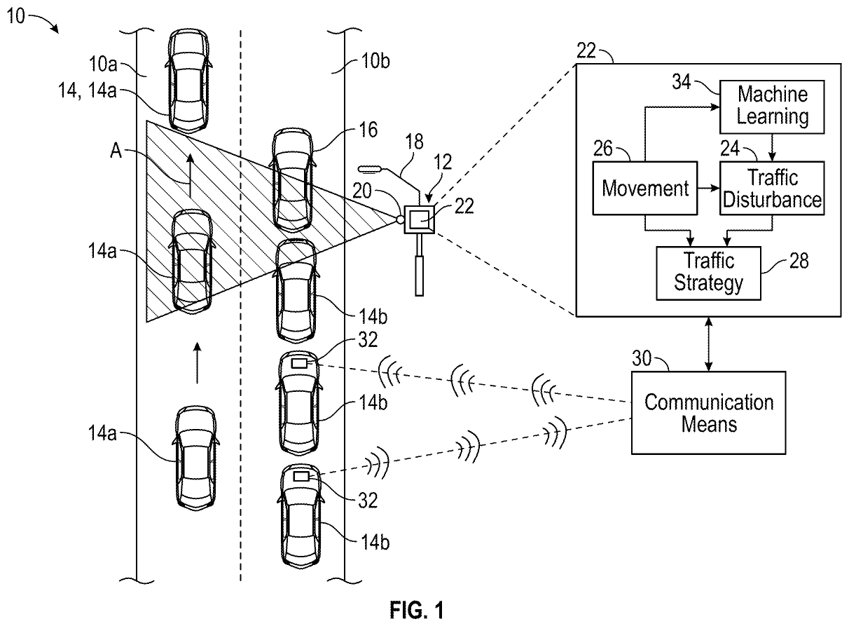

FIG. 1 illustrates a segment of road 10 incorporating a traffic command system 12. FIG. 1 illustrates a simple two-lane road with a first lane (or left lane) 10a and a second lane (or right lane) 10b. Vehicles 14 travel on the road 10, with vehicles 14a that travel in the first lane 10a and vehicles 14b that travel in the second lane 10b both traveling in a single direction A.

FIG. 1 further illustrates a traffic disturbance 16 in the second lane 10b. The traffic disturbance 16 may be a vehicle (disturbing vehicle 16) that has slowed or stopped in an attempt to merge into the left lane, or otherwise is proceeding too slowly. The traffic disturbance 16 may also be an immobile disturbance blocking the second lane 10b, such as a broken down or otherwise immobilized vehicle, a traffic accident, or road construction. Traffic command system 12 is configured to issue traffic commands to address traffic disturbance 16 in an optimized manner. The traffic command system 12 may be implemented in coordination with law enforcement so that the traffic commands are issued in accordance with local laws and/or carry the force of law.

Traffic command system 12 may be mounted on a static structure 18. Static structure 18 may be road infrastructure, such as a structure supporting traffic lights, utility poles, or street lights. Alternatively, static structure 18 may be a stand-alone structure.

The traffic command system 12 includes sensors 20 capable of detecting and obtaining details of a traffic disturbance 16. The sensors 20 are also capable of obtaining real-time movement characteristics of all vehicles 14 in the proximity of the traffic disturbance 16. The movement characteristics of a vehicle 14 include their speed, acceleration, location, and movement direction. The sensors 20 may consist of radars, LiDARs, ultrasonic, vision based sensors, or any other appropriate sensor. As illustrated in FIG. 1, sensors 20 may positioned locally with the traffic command system 12 and mounted on the static structure 18.

In another example, sensors 20 may be mounted on vehicles 14 as part of a V2X (Vehicle-to-Everything) or V2I (Vehicle-to-Infrastructure) system. In this example, vehicle 14 mounted sensors 20 may obtain the movement characteristics of the vehicle 14 they are mounted on, and/or details of surrounding vehicles 14 and traffic disturbances 16. For example, a traffic disturbance 16 may be detected by sensors 20 of the closest vehicle 14 to the traffic disturbance. As another example, sensors 20 of multiple vehicles 14 may coordinate to obtain surrounding traffic disturbance 16 details and surrounding vehicle 14 movement characteristics. The sensors 20 being mounted on vehicles 14 may have a better vantage point compared to sensors 20 mounted on a static structure 18, but vehicles 14 with V2X or V2I capability are required. In another example, sensors 20 mounted on a static structure 18 and sensors 20 mounted on vehicles 14 work in combination to obtain traffic disturbance 16 details and vehicle 14 movement characteristics.

The traffic command system 12 further includes a controller 22. Controller 22 includes a traffic disturbance module 24, a movement module 26, and a traffic strategy module 28. The traffic disturbance module 24 detects the occurrence of a traffic disturbance 16 and categorizes the traffic disturbance 16 into a category. The general categories of traffic disturbances 16 addressed by the traffic command system 12 are a mobile disturbing vehicle 16 that has slowed down or halted, to attempt to merge for example, or an immobile disturbance 16 in one lane 10a/10b of road 10. The movement module 26 is in communication with the sensors 20 to access data or information relating to the real-time movement characteristics of vehicles 14 in the proximity of a traffic disturbance 16. The traffic strategy module 28 uses the traffic disturbance category (communicated by the traffic disturbance module 24) and the vehicle movement characteristics (communicated by the movement module 26) to develop a traffic alleviation strategy. The traffic alleviation strategy may be a set of determined movements of vehicles 14 in the proximity of traffic disturbance 16 that will optimally reduce overall traffic congestion in the proximity of the traffic disturbance.

As illustrated in FIG. 1, the controller 22 may be positioned locally as part of traffic command system 12 and be specific to road 10. In another embodiment, controller 22 may be located remotely at a centralized hub and communicating and controlling multiple different traffic command systems 12 at multiple roads.

The traffic command system 12 further includes a communication means 30 instructed by the controller 22 to communicate traffic commands to vehicles 14 when appropriate. Communication means 30 is preferably a data transmitter and broadcasts to a processor 32 of a vehicle 14 through one of Wi-Fi, Bluetooth, DSRC, or any other appropriate date communication method. The traffic commands may comprise movement instructions according to the traffic alleviation strategy developed by the traffic strategy module 28. In one example, the vehicles processor 32 may display the traffic command to the driver of the vehicle through a vehicle display, which may be a heads-up display on the vehicle's windshield. In another example, the vehicle processor 32 may communicate with the vehicles speakers to deliver an audible traffic command to a driver. In another example, the vehicle 14 is an autonomous vehicle and the vehicles processor 32 autonomously moves the vehicle 14 in accordance with the traffic command.

Communication means 30 may also be a receiver capable of receiving information or data transmitted by the vehicle processor 32 and communicating that information to the controller 22. Information transmitted by vehicle processor 32 to communication means 30 may include navigational data on the vehicle's 14 intended route and the estimated drivetime of that route. The controller 22 and vehicle processor 32 may also communicate to determine additional drivetime associated with a disturbing vehicle 16 missing a turn or exit by calculating a new route for the vehicle proceeding straight and comparing it to the prior route that involved taking the turn or exit. The vehicle processor 32 can also transmit information related to the status of the vehicle 14 to the communication means 30, including any detected malfunctions. Further, the vehicle processor 32 can analyze and transmit information obtained by sensors 20 that are mounted on the vehicle 14.

The controller 22 may further include a machine learning module 34. The machine learning module may comprise a neural network or any other appropriate known machine-learning algorithm. In one example, the machine learning module 34 may communicate with or be a part of the traffic disturbance module 24, and learn to categorize traffic disturbances 16. In this example, the machine learning module 34 may learn by grouping eventual movement outcomes of traffic disturbances 16 (communicated by the movement module 26) with imaging features of traffic disturbances 16 (communicated by the sensors 20) over a period of time. Movement outcomes of the traffic disturbances 16 may include it merging or remaining stationary for a prolonged period.

As an example, the machine learning module 34 may learn to associate imaging features such as a blinking turn signal or a slanted orientation of a disturbing vehicle 16 in the lane 10b with the vehicle 16 eventually merging. As another example, the machine learning module 34 may learn to associate flashing hazard lights or damage to the disturbing vehicle 16 with the disturbance 16 remaining stationary. Over time, the machine learning module 34 develops traffic disturbance identification data comprising the groupings of traffic disturbance 16 image features and eventual outcomes. The traffic disturbance identification data may further include groupings of information provided by the processor 32 of the disturbing vehicle 16 in combination with imaging features and outcomes.

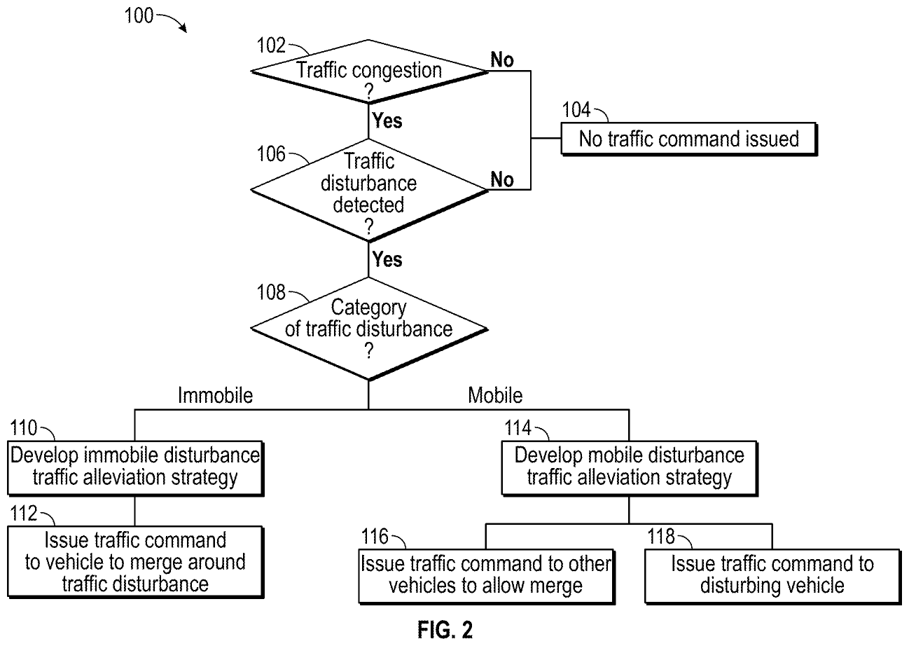

FIG. 2 illustrates a simplified algorithm 100 performed by the controller 22 to issue traffic commands. At step 102 information communicated from the movement module 26 is used to determine whether traffic congestion exists in a segment of the road 10. If there is not a significant number of vehicles 14 on the road 10, such that vehicles 14 can easily maneuver around a disturbance in one of the lanes 10a/10b, then at step 104 the controller 22 will determine to not issue a traffic command.

At step 106 the traffic disturbance module 24 detects the occurrence of a traffic disturbance 16, and at step 108 the traffic disturbance module 24 categorizes a detected traffic disturbance 16. If no traffic disturbance 16 is detected at step 106, the controller 22 will again determine to not issue a traffic command at step 104.

In one example, the traffic disturbance module 24 may detect and categorize the traffic disturbance 16 by analyzing imaging data or other information communicated by the sensors 20. The traffic disturbance module 24 may compare the traffic disturbance 16 to the traffic disturbance data developed by the machine learning module 34. The traffic disturbance module 24 may recognize certain image features of the traffic disturbance 16 that are indicative of either a merging or immobilized vehicle.

In another example, the traffic disturbance module 24 may analyze data transmitted by the processor 32 of the disturbing vehicle 16 to the communication means 30 to detect and categorize the traffic disturbance 16. For example, route information of the disturbing vehicle 16 may indicate that it is attempting to merge to another lane (such as lane 10a) in order to make a turn or enter a freeway ramp. As another example, diagnostic information of the disturbing vehicle 16 may indicate that it is an immobile disturbance. The traffic disturbance module 24 also may detect and categorize traffic disturbance 16 by analyzing both imaging data provided by the sensors 20 and data provided by the processor 32 of the disturbing vehicle 16 in combination.

If the category of traffic disturbance is an immobile disturbance 16, the traffic strategy module 28 generates an immobile disturbance traffic alleviation strategy at step 110. The traffic alleviation strategy for this category includes movements of vehicles in both lanes 14a/14b that are behind the traffic disturbance 16 that will get vehicles 14 around or pass traffic disturbance 16 in an optimal manner. This may include a merge pattern generally referred to as a “zipper merge,” wherein vehicles 14 in the first lane 10a and vehicles 14 in the second lane 10b alternate proceeding past the traffic disturbance 16. Said another way, vehicles 14a in the undisturbed first lane 10a first allow a vehicle 14b from the second lane 10b that are approaching the traffic disturbance 16 to merge into the first lane 10a ahead of them prior to proceeding past the traffic disturbance 16. At step 110, the traffic strategy module 28 may also analyze movement characteristics of vehicles 14a/14b communicated by the movement module 26 in order to determine optimal opportunities for vehicles 14b in the obstructed second lane 10b to merge into the first lane 10a. The traffic alleviation strategy developed at step 110 attempts to optimally address traffic congestion caused by the traffic disturbance 16 by developing vehicle movements that will either optimize vehicle throughput (i.e. the rate of vehicles passing the immobile disturbance 16) or optimize to reduce the total additional drivetime of all vehicles affected by the traffic disturbance 16.

At step 112, the communication means 30 is instructed by the controller 22 to deliver traffic commands to the processors 32 of vehicles 14a/14b in both lanes 10a/10b instructing movement according to the immobile disturbance traffic alleviation strategy developed at step 110.

If the category of traffic disturbance is a mobile disturbance 16 the traffic strategy module 28 generates a mobile disturbance traffic alleviation strategy at step 114. This traffic alleviation strategy may generally include optimal movements of the disturbing vehicles 16 and/or optimal movements of other vehicles 14 in the proximity of the disturbing vehicle 16. For example, if the disturbing vehicle 16 is slowing down or halting in an attempt to merge, the traffic alleviation strategy may include the disturbing vehicle 16 proceeding straight or other vehicles 14a allowing the disturbing vehicle 16 to merge into their lane 10a. The traffic alleviation strategy developed at step 114 may be developed by determining the total additional drivetime associated with the disturbing vehicle 16 proceeding straight (i.e. the additional time in the disturbing vehicle's route resulting from a missed turn or exit) and comparing it to the total additional drivetime associated with another vehicle 14 allowing the disturbing vehicle 16 to merge. The total additional drivetime associated with allowing disturbing vehicle 16 to merge may be a summation of the delay caused to all vehicles 14a that have to slow to allow the merge. At step 114, the traffic strategy module 28 may also analyze movement characteristics of vehicles 14a and the disturbing vehicle 16 communicated by the movement module 26 in order to determine an optimal opportunity for the disturbing vehicle 16 to merge.

As another example, if the disturbing vehicle 16 is simply proceeding too slowly relative to the flow of traffic on the road 10, the traffic alleviation strategy may include the disturbing vehicle 16 speeding up.

If the traffic alleviation strategy developed at step 114 includes facilitating the disturbing vehicle 16 merging, the communication means 30 is instructed by the controller 22 at step 116 to deliver traffic commands to the processor 32 of other vehicles 14a to instruct slowing to allow the merge. If the traffic alleviation strategy developed at step 114 includes movement of the disturbing vehicle 16, the communication means 30 is instructed by the controller 22 at step 118 to deliver traffic commands to the processor 32 of the disturbing vehicle 16 instructing movements according to the traffic alleviation strategy, such as instructions to proceed straight or speed up. The communication means 30 may also communicate with the disturbing vehicle 16 at step 118 and other vehicles at step 116 simultaneously to effectuate the traffic alleviation strategy.

The traffic alleviation strategy developed at step 114 may also include determining a time limit for the disturbing vehicle 16 attempting to change lanes. In one example, the time limit may be twenty seconds or less, or more narrowly ten seconds or less. In another example, the time limit is determined by a calculation considering the additional drivetime of the disturbing vehicle 16 if it proceeds straight and the total additional drivetime of other vehicles 14 affected by the disturbing vehicle 16 over the length of the time limit. In this example, the time limit may be set such that the total additional drivetime of the disturbing vehicle 16 proceeding straight is equal to the total additional drivetime of other vehicles 14 if the disturbing vehicle 16 waits the full time limit before merging or proceeding straight. A traffic command may then be issued to the disturbing vehicle 16 at step 118 to proceed straight after the time limit has expired.

The traffic command issued at step 118 may also send a signal to the processor 32 of the disturbing vehicle 16 that instructs updating the navigation route on the vehicle's display. In this manner, the display will show an updated route prior to the vehicle 16 actually deviating from the initial intended route. This may reduce drivetime and stress to a driver associated with missing a turn by helping the driver to immediately know the turns to get back on course.

Although traffic command system 12 is illustrated and described with respect to a simple two-lane road 10, one would understand that this disclosure is also applicable to roads with any number of lanes. Further, it should also be understood that traffic command system 12 can analyze multiple traffic disturbances 16 at once and develop a traffic alleviation strategy which optimally addresses all traffic disturbances 16 on the segment of road 10 simultaneously.

Although the different non-limiting examples are illustrated as having specific components, the examples of this disclosure are not limited to those particular combinations. It is possible to use some of the components or features from any of the non-limiting examples in combination with features or components from any of the other non-limiting examples. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method, comprising:
detecting a traffic disturbance in a first lane of a road with a plurality of lanes;
categorizing the traffic disturbance into a category;
sensing movement characteristics of a plurality of vehicles in the proximity of the traffic disturbance;
developing a traffic alleviation strategy based on the category of the traffic disturbance and the movement characteristics; and
sending at least one traffic command to a processor of at least one vehicle based on the traffic alleviation strategy.

2. The method of claim 1, wherein the step of developing the traffic alleviation strategy includes determining vehicle movements that will reduce overall traffic congestion in the proximity of the traffic disturbance.

3. The method of claim 1, wherein the step of developing the traffic alleviation strategy includes determining vehicle movements that will reduce a total estimated drivetime of all vehicles on the road in the proximity of the traffic disturbance.

4. The method of claim 1, further comprising storing traffic disturbance identification data prior to the step of detecting, and wherein the step of categorizing includes comparing the traffic disturbance to the traffic disturbance identification data.

5. The method of claim 1, wherein the category of the traffic disturbance is a disturbing vehicle attempting to merge from the first lane to a second lane of the road.

6. The method of claim 5, wherein developing the traffic alleviation strategy includes determining a time limit for allowing the disturbing vehicle to attempt to change lanes, and the traffic command is communicated after the time limit.

7. The method of claim 5, wherein the traffic command comprises one of instructing the disturbing vehicle to proceed straight and instructing a vehicle in the second lane to allow the disturbing vehicle to merge into the second lane.

8. The method of claim 5, wherein developing the traffic alleviation strategy includes determining additional drivetime associated with the disturbing vehicle proceeding in the first lane and determining additional drivetime associated with a vehicle in the second lane allowing the disturbing vehicle to merge into the second lane.

9. The method of claim 1, wherein the category of the traffic disturbance is an immobile disturbance and the traffic command comprises instructing an alternating merge pattern.

10. A system comprising:
one or more sensors detecting a traffic disturbance in a first lane of a road with a plurality of lanes and detecting movement characteristics of vehicles in the proximity of the traffic disturbance, the sensors communicating data to a controller;
a communication means in communication with the controller;
wherein the controller categorizes the traffic disturbance into a category;
wherein the controller develops a traffic alleviation strategy based on the category of the traffic disturbance and the movement characteristics; and
wherein the controller instructs the communication means to communicate a traffic command to a processor of at least one vehicle based on the traffic alleviation strategy.

11. The system of claim 10, wherein the traffic alleviation strategy includes determined vehicle movements that will reduce a total estimated drivetime of all vehicles on the road in the proximity of the traffic disturbance.

12. The system of claim 10, wherein the category of the traffic disturbance is a disturbing vehicle attempting to merge from the first lane to a second lane of the road.

13. The system of claim 12, wherein the traffic command comprises one of instructing the disturbing vehicle to proceed straight and instructing a vehicle in the second lane to allow the disturbing vehicle to merge into the second lane.

14. The system of claim 12, wherein the controller develops the traffic alleviation strategy by determining additional drivetime associated with the disturbing vehicle proceeding in the first lane and determining additional drivetime associated with a vehicle in the second lane allowing the disturbing vehicle to merge into the second lane.

15. The system of claim 10, wherein the category of the traffic disturbance is an immobile disturbance and the traffic command instructs an alternating merge pattern.

16. The system of claim 10, wherein the controller incorporates a machine-learning component to develop traffic disturbance identification data, and wherein the controller categorizes the traffic disturbance by comparing the traffic disturbance to the traffic disturbance identification data.

17. The system of claim 10, wherein the traffic disturbance is a disturbing vehicle and the controller receives information from a processor of the disturbing vehicle to categorize the traffic disturbance.

18. The system of claim 10, wherein the traffic command instructs the processor to autonomously move the at least one vehicle.

19. A non-transitory computer readable medium including instruction executable by at least one processor, the instructions comprising:
instructions executed by the at least one processor that prompt categorizing a traffic disturbance in a first lane of a road with a plurality of lanes into a category;
instructions executed by the at least one processor that prompt developing a traffic alleviation strategy based on the category of the traffic disturbance and movement characteristics of vehicles in the proximity of the traffic disturbance,
instructions executed by the at least one processor that prompt sending at least one traffic command to a processor of at least one vehicle based on the traffic alleviation strategy.

20. The non-transitory computer readable medium of claim 19, wherein developing the traffic alleviation strategy includes determining vehicle movements that will reduce a total estimated drivetime of all vehicles on the road in the proximity of the traffic disturbance.
